(19) United States
(12) Patent Application Publication
(10) Pub. No.: US 2008/0059869 A1
(43) Pub. Date: Mar. 6, 2008

(54) LOW COST, HIGH PERFORMANCE ERROR DETECTION AND CORRECTION

(75) Inventors: Forrest D. Brewer, Santa Barbara, CA (US); Gregory W. Hoover, San Diego, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: THE REGENTS OF THE UNIVERSITY OF CALIFORNIA, Oakland, CA (US)

(21) Appl. No.: 11/848,537

(22) Filed: Aug. 31, 2007

Related U.S. Application Data
(60) Provisional application No. 60/824,420, filed on Sep. 1, 2006.

(51) Int. Cl. G06F 11/00

(52) U.S. Cl. 714/801; 714/E11.001

(57) ABSTRACT

A method and apparatus provides the ability to build and use low-density linear parity-check (LDPC) codes for implementing error detection and correction (EDC). A number of data bits and a number of parity bits are received. While the number of data bits and number of parity bits are within a defined threshold with respect to each other, codes are created. The codes are based on the number of parity bits as combinations of values for the parity bits. The codes are sorted into weight subsections with each subsection containing having the same weight. A subset of each subsection is determined based on the number of data bits with the subset containing codes representing a lowest number of inputs to a parity tree for a given parity bit. An identity matrix of a size of the number of data bits is appended to the subset.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 60/824,420, filed Sep. 1, 2006, by Forrest D. Brewer and Gregory W. Hoover, entitled “CONCURRENT ERROR DETECTION AND CORRECTION,” attorneys' docket number 3074.194-US-P1.

### BACKGROUND OF THE INVENTION

1. Field of the Invention

The invention is related to a method for concurrent error detection and correction.

2. Description of the Related Art

(Note: This application references a number of different publications as indicated throughout the specification by reference numbers enclosed in brackets, e.g., [x]. A list of these different publications ordered according to these reference numbers can be found below in the section entitled “References.” Each of these publications is incorporated by reference herein.)

The spread of technology into hostile environments has increased the need for dependable machine execution without compromising performance levels. The de facto model used for describing fault tolerant systems is a single-event upset (SEU) model, which specifies a maximum of one error per cycle. While SEU compliant machines should be able to operate under constant error rates of one fault per cycle, many do not, due to prohibitive overhead, and thus many machines are often only partially SEU tolerant.

In general, existing error detection and correcting (EDC or EDAC) solutions suffer from high cost and fail to provide adequate levels of resilience. Real-world applications require EDC techniques capable of providing tolerance with constant error rates far in excess of the SEU model. In order to be effective, these techniques must provide elevated levels of resilience with relatively small overhead, without compromising machine performance. These problems may be better understood with a detailed description of EDC techniques and prior art solutions.

Selective addition of redundancy in digital designs allows EDAC techniques to recover a potentially large number of transient and static errors. This field is dominated by two techniques that effectively establish the bounds on latency and area for redundant implementations. Triple modular redundancy (TMR) provides minimal latency impact at a cost of more than three times (3×) in area by triplicating logic and suppressing errors via voting [13]. While TMR is well suited for latency-sensitive applications [7], such as high-performance processors, its extreme area overhead makes it impractical for space-constrained designs and replication of large components, such as memories. By contrast, Hamming codes provide optimal density in terms of added storage (flip-flop/memory) overhead, but incur significant latency penalties due to deep parity trees and decoding logic. The efficacy of a densely packed redundant code can be seen for dense groups of registers, such as embedded memories. While effective, neither technique provides a middle ground solution capable of meeting design constraints in many applications. To this end, one or more embodiments of the invention present a family of provably optimal linear codes with selectable performance and area cost trade-offs, allowing design-specific constructions capable of meeting a wide range of constraints.

The single event upset (SEU) fault model is the de-facto standard for fault tolerant design and research. In this model, faults are characterized as occurring at most once per cycle, where fault location and duration are unknowns. It is often assumed that error probability is uniform per bit; and thus dynamic error screening is a substantial mitigator of system faults [2]. Such an assumption implies that the rate of random errors is low enough that the probability of multiple errors in a single word is small—this is the classical fault model for memory EDAC. Though the SEU model is effective for terrestrial radiation fault mechanisms, electrical (EMI [electromagnetic interference]) and space-borne radiation effects may generate multiple faults, especially in nanometer scaled memory systems. For this reason, EDAC techniques capable of efficient multiple error correction are of great interest. Furthermore, the tendency for combinatorial logic errors to be automatically screened via logic and timing mechanisms increases the applicability of EDAC memory techniques over plenary SEU fault tolerant techniques like TMR [3].

Though the low latency of TMR implementations makes it an appealing choice for high speed logic, 3× replication is impractical in many cases. This is especially true given the dominance of memory area in modern designs. The fault correction capabilities of TMR are additionally limited by an inability to correct multi-bit errors when they occur in multiple copies (voting requires two out of three copies to be correct). Three-way voting is highly ineffective on pattern-dependent error phenomenon commonly experienced in memories. While one might think voting logic can be optimized to address these scenarios, it becomes increasingly difficult to route wires given latency and area constraints.

EDAC, on the other hand, has seen limited use in high performance digital logic due to the deep parity trees and dense decoding circuits that typically arise from Hamming-based implementations. Poor scalability is a direct consequence of the code density—each syndrome bit of a Hamming code is a function of ½ of the codeword, requiring [n/2]−1 binary XOR gates. The logic tree for each parity bit has depth lg₂ (n)−1, resulting in latencies that are difficult to mitigate in high performance designs. A more insidious delay is related to the full binary decoding circuits required for correction and the loading on parity trees to drive the decoding logic. Furthermore, design area is impacted by the number of parity trees necessary for single error correction (SEC). As block size increases, both latency and area increase due to added fan in delay and routing congestion of syndrome decoding networks.

Despite the above, Hamming-based EDAC solutions are used in many memory applications to provide SEC and double-error detection (DED) at minimal bit cost [19], [18], [4], [5]. Hamming and other distance-3 codes have been shown to be optimal [19], [18] and used in a number of fault tolerant architectures [11], [16], [9]. Intense design scaling has created the common practice of multiple redundant columns in larger memory instances to enhance design production yield. In practice, the marginal cost of a few extra memory columns is relatively low, making low-density encoding schemes feasible.

### SUMMARY OF THE INVENTION

The present invention discloses a method for concurrent error detection and correction (EDC). Specifically, the present invention discloses a designer-driven, automated method for synthesizing EDC in a digital circuit through use of a subset of low density linear parity check (LDPC) codes, wherein the codes provide a circuit-based solution for local error recovery at low cost. Circuit-efficient encodings are generated that inherently provide tolerance to constant error rates in excess of one error per cycle. Moreover, these codes allow for lower circuit complexity and cost than existing techniques such as Hamming, Partitioned Hamming and triple modular redundancy (TMR). While existing techniques aim to reduce the overhead in terms of the number of check bits, this technique aims specifically to reduce circuit area, delay, and power.

### BRIEF DESCRIPTION OF THE DRAWINGS

Referring now to the drawings in which like reference numbers represent corresponding parts throughout:

FIG. 1A illustrates an exemplary transmitter/encoder in accordance with one or more embodiments of the invention;

FIG. 1B illustrates an exemplary receiver/decoder in accordance with one or more embodiments of the invention;

FIG. 2 illustrates an error detection and correction circuit for a six (6) bit partitioned (6,3) LDPC code in accordance with one or more embodiments of the invention;

FIG. 3 illustrates a synthesized delay of partitioned Hamming and Opt EDAC in accordance with one or more embodiments of the invention;

FIG. 4 illustrates synthesized area figures for new codes (e.g., for Partitioned Hamming and Opt) in accordance with one or more embodiments of the invention; and

FIG. 5 is a flow chart illustrating the logical flow for building and using a family of low-density linear parity-check (LDPC) codes used for implementing error detection and correction (EDC) in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

The present invention comprises a family of linear parity check codes that lend themselves to optimal EDC circuits in terms of circuit area, delay, and power. Embodiments provide a technique for constraint-driven construction of optimal and near-optimal codes capable of multi-bit error correction. Additionally, the custom-built codes may be automatically applied to digital circuits including finite-state-machines (FSM) and memories.

The novel EDC technique allows for the construction of machines that are resilient to single bit errors with relatively little overhead in terms of both added redundancy and logic complexity. The new method can be expanded to provide coverage for many kinds of multiple error conditions, and there is potential that this technology will allow construction of machines capable of “correct” behavior even under constant error rates well in excess of one error per cycle.

Triple modular redundancy (TMR) is the leading technique used in the prior art. However, the large overhead of TMR forces many systems to implement only partial TMR, resulting in inadequate SEU tolerance. Embodiments of the invention add redundancy while using far fewer check bits and related overhead than TMR, and while realizing error correction with similar logic complexity. Additionally, this new technique can decrease encoder/decoder delay by 30%-50%, as compared to current optimized/partitioned Hamming Codes, while simultaneously saving 10%-15% of the area.

This novel fault tolerance technique is vastly superior to existing EDAC solutions, which suffer from high cost and fail to provide adequate levels of resilience. Real-world applications of this discovery include:

machine operation in hostile environments, such as deep space and locations with high levels of radiation, where dependable execution is critical;

upgrade machine performance while lowering cost as compared to current EDC techniques; and

on-chip memory compilers.

In view of the above, one or more embodiments of the invention provide a novel technique for EDAC targeting memory and other parallel access devices. Through the use of a subset of replicated low-density parity-check (LDPC) codes, comparable error recovery is achieved at reduced cost in terms of both latency and area. By utilizing a sparse encoding, the logic required for error detection and correction can be reduced to as little as 4 levels of 2-input gates. Additionally, sparse encoding of error syndromes allows correction of a number of multi-bit errors in addition to single-bit errors. It can be shown that these codes are provably optimal over the set of linear codes and a technique for generating measured levels of fault tolerance over a variety of design constraint points is provided.

### Low Density Parity Check (LPDC) Code Architecture

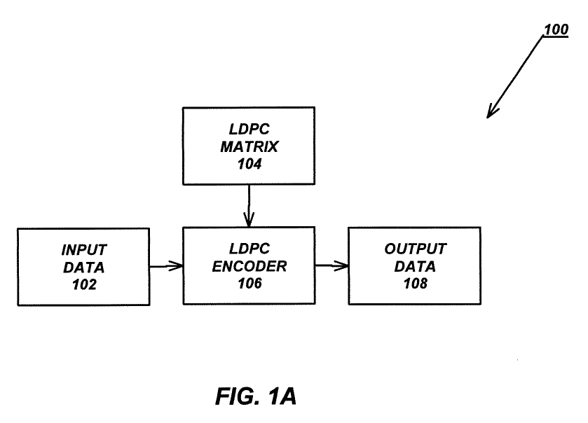

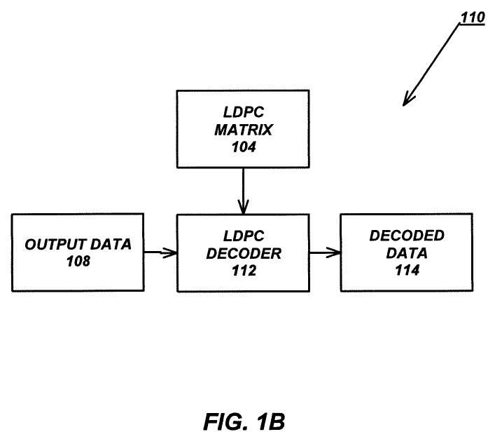

FIG. 1A illustrates an exemplary transmitter/encoder 100 that generally includes, inter alia, input data 102, LDPC matrix/code 104, LDPC encoder 106, and output data 108. The input data 102, is a vector having a specified length for the LDPC matrix 104. The output data 108, is also a vector. The LDPC matrix 104 may also comprise a parity-check matrix.

The LDPC encoder 106 produces the output data 108, which is a vector that comprises the results of the vector of the input data 102 being multiplied on the right by the LDPC matrix 104.

FIG. 1B illustrates an exemplary receiver/decoder 110 that generally includes, inter alia, the received/output signal 108 as input, LDPC matrix/code 104, LDPC decoder 112, and decoded data 114 as output. This output data 108 is processed by the LDPC decoder 112, using the LDPC matrix/code 104, to produce the decoded data 114. The decoded data 114 is an estimate of the input data 102.

Those skilled in the art will recognize that the exemplary transmitter/encoder 100 and receiver/decoder 110 illustrated in FIGS. 1A and 1B are not intended to limit the present invention. Indeed, those skilled in the art will recognize that any combination of the above components, or any number of different components, hardware, and/or software, may be used to implement the present invention.

### Low Density Parity Check Codes

Originally conceived in 1960 [6], low-density parity-check (LDPC) codes fell out of research attention for many years due to the computational effort involved in encoder and decoder implementations [10]. In the last decade, these codes have experienced a dramatic comeback offering both encoding and decoding algorithms with linear time complexity and efficiencies near the Shannon limit [17]. A low-density parity-check code (or Gallager code) is a linear block code that has a parity-check matrix, H, every row and column of which is ‘sparse’ [14] (vis ‘Low Density’). Valid codewords satisfy the requirement that all check nodes are of even parity.

Since the bitwise XOR of any two codes would also satisfy the parity check, linear codes have the property that the bitwise XOR of any two codewords is another codeword. Using the scalars ‘0’and ‘1’ and the above XOR rule as a linear analog, all possible codewords for a given parity check matrix form a linear vector space. For this reason, once the parity matrix is known, everything about the set of all codewords is also known, including properties such as code distance (which determines the number of errors than can be corrected). It has been shown that efficient Gallager codes can be heuristically found at random, subject to constraints on row and column weights [12]. A subset of LDPC codes, staircase codes, provide linear time encoding and decoding techniques. These codes can be described by a parity check matrix where the columns corresponding to parity bits form a bi-diagonal sub-matrix.

Various heuristic decoding methods exist, providing decoding for a range of codes that trade off implementation complexity with efficiency. In general, these encoding algorithms work by assigning message bits to variable nodes and calculating values for the remaining nodes. While a simplistic solution can be achieved by directly solving the parity check equations, this method involves the whole parity-check matrix and has complexity quadratic in the block length [10]. By maintaining column weights of two (2) or less, staircase codes offer linear encoding complexity while providing acceptable levels of redundancy at rates of ½ or better.

LDPC codes exhibit excellent efficiency provided an optimal decoder exists. In general, decoding LDPC codes is NP-complete and work thus far has yet to discover an efficient, optimal algorithm [14]. Several efficient decoding strategies exist, however, for specific codes or codes meeting certain conditions. Given sufficient processing, these solutions provide excellent error correction, achieving complete correction of ½ rate codes with 7.5% added noise [14]. Despite excellent error tolerance, these methods are predominantly message passing, belief propagation (or soft-decision) algorithms requiring multiple iterations and floating point precision to achieve efficiency near the Shannon capacity limit.

In one or more embodiments of the invention, linear parity check codes are examined that have minimal density and thus minimal encoding/decoding cost in terms of either gate area or gate delay. A goal is to find a set of provably minimal density codes which allow trade-offs between the number of parity bits and implementation area or encoding/decoding delay. The parity check solution problem may be finessed by re-writing the check codes in standard systematic form (for a linear code) which allows the data part of the code word to be identical to the un-encoded input. Each parity check-bit is realized by a parity tree over subsets of the data inputs. Any linear code can be written in this form including both Hamming codes and TMR voting. Furthermore, current practical techniques for large parallel EDAC make use of code replication whereby shorter codes are used multiple times to cover a large data block. Such replications are also linear codes, but provide decreased gate count and latency—Hamming correction on 512 data bits requires thousands of XOR gates.

### A Simple Optimal Weight Linear Code

An optimal family of linear parity check codes can be utilized in accordance with one or more embodiments of the invention. Such an optimal family incur various encoding/decoding delays and may have area bounds.

Consider a simple code 104 with three (3) data inputs (d₁, d₂, and d₃) and three parity check bits (p₁, p₂, and p₃): each data input is encoded as itself (the code is systematic), while each parity bit is defined as the XOR of two of the data bits (p₁=d1 XOR d₂; p₂=d₁ XOR d₃; p₃=d₂ XOR d₃). Since there are exactly three (3) unique pairs, an error in any data bit (d₁-d₃) will also invert two of the parity bits (p₁−p₃). An error in a parity bit (p₁−p₃) only inverts that parity bit. Such a code is encoded using the matrix equation below. Note that the usual operators of addition and multiplication are simplified to XOR and AND respectively.

$$[ \begin{matrix}{d}_{1} \\ {d}_{2} \\ {d}_{3}\end{matrix} ] [ \begin{matrix} \\ I \\ \end{matrix} \begin{matrix}1 & 1 & 0 \\ 1 & 0 & 1 \\ 0 & 1 & 1\end{matrix} ] = [ \begin{matrix}{d}_{1} & {d}_{2} & {d}_{3} & {p}_{1} & {p}_{2} & {p}_{3}\end{matrix} ]$$

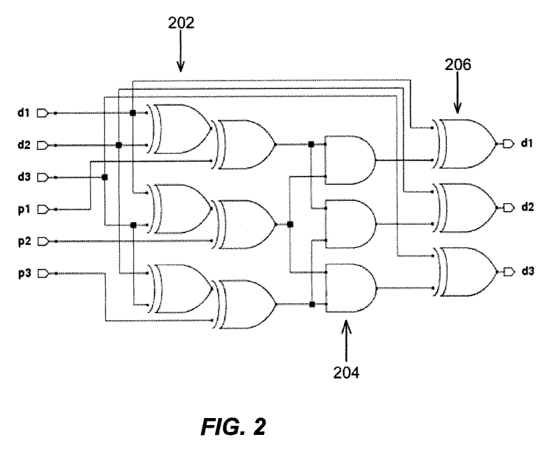

Decoding this code is easy. The parity values (p₁−p₃) (called the syndrome) are recalculated and compared with the stored parity values. If one of the data bits (d₁−d₃) changed between the two parity checks, two of the parity bits must be inverted. Since each pair of parity bits determines a unique data bit, one knows which data bit to invert to restore the data. In many applications, errors in the parity bits do not need to be corrected—any single error in the parity will not force any correction. A circuit to implement the decoding process is shown in FIG. 2. Thus, FIG. 2 illustrates an error detection and correction circuit for a six (6) bit (6,3) LDPC code.

The decode latency for this tiny code is 3 XOR+1 AND delay. The parity trees have 3 inputs: 2 from the data to build the new parity 202 and the stored parity value to check. Determining the bit to correct requires a single 2 input AND gate 204, while the correction requires an XOR 206. One may note that this code is precisely one (1) column short of a Hamming code, a fact that allows a great deal of improvement by not requiring complete binary decoding of the syndrome. In particular, it uses 2-input rather than 3-input AND gates and thus lowers the load on the previous stage by 33%. Examining the parity check matrix above, it can be noted that, in general, the number of inputs to each parity tree for a given parity bit is equal to the weight (number of 1's) of its respective row. As a short hand, henceforth, the identity matrix will be omitted and only the parity sub-matrix will be described.

One can generalize the previous code for a given number of p parity bits: such a code has

$$d = ( \begin{matrix}p \\ 2\end{matrix} )$$

data bits and row weight 2. Thus the area of the code is p²+p+d gates while the decoding latency is 2+┌l₂ (p)┐, when implemented in 2-input gates. This seemingly trivial code is a viable alternative to Hamming codes for many applications. For instance, a 32-bit implementation requires 9 parity bits (instead of 6 for Hamming), but requires just 112 gates for the decoder and has decode latency of 6 2-input gate delays. A Hamming based 32-bit EDAC uses at least 234 2-input gates and has a decode latency of 9 gates. Thus for a nominal amount of extra redundancy, the cost of decoding for single error correction can be substantially reduced, both in area and time. In general, substantial savings can be realized for arbitrary bit-width codes by making a relatively small increase in the number of parity bits. Following from a simple construction algorithm, optimal codes (in the sense of minimal overall weight) can be generated for any combination of d and p that has sufficient redundancy to be single error correcting.

Optimizing the area and delay cost of the code is accomplished through manipulation of the column and row weights respectively. Minimizing the overall weight reduces the area, while individual row weights influence the delay of each independent parity check function. Since row weight determines syndrome size and hence decoding complexity in both parity trees and syndrome decoding networks, its effects are directly reflected in the resulting implementation delay. A more detailed analysis shows that voting circuits (e.g. 2 of 3 majority gates) are cheaper and faster than 3-input parity trees in classic static CMOS. In the interest of latency optimality, one may be careful to allocate columns such that the maximum weight of all rows is minimal. A simple example of such a balanced allocation is shown at the end of this section. This allocation has the effect that if there is a sufficient number of parity bits (i.e. p=2d) then the code returned is TMR voting.

The construction works by allocating parity check code-words for each column weight in turn, starting from weight two (2) and continuing until all data bits are covered. (Row weights of 0 or 1 cannot be so allocated—they conflict with the unique decoding of errors in the parity bits themselves). The allocation can always be done if the data width is less than the number of heavier weight words: d≦2^{p}−p−1. The procedure is shown as Algorithm 1.

Algorithm 1
Minimal Weight Code Construction

Algorithm1 (d = data width; p = parity allocation) {

w = 2 = initial row weight; a = 0 = gate total;
cw = 0 = column weight; t = 0 = gate delay;
if (d > 2^{p} − p − 1) exit;
while (d >= 0) {

$if ( d \geq ( \begin{matrix}p \\ r\end{matrix} ) ) \{$

$allocate ( \begin{matrix}p \\ w\end{matrix} ) rows of weight w from sorted list .$
$\begin{matrix}a = a + p ( ( \begin{matrix}p - 1 \\ w - 1\end{matrix} ) - 1 ) ; cw = cw + ( \begin{matrix}p - 1 \\ w - 1\end{matrix} ) ; \\ d = d - ( \begin{matrix}p \\ w\end{matrix} ) ;\end{matrix}$

} else {

allocate d rows of weight w from sorted list;
$a = a + pdw ; cw = cw + ⌈ \frac{dw}{p} ⌉ ; d = 0 ;$

}
w = w + 1;

}
a = a + dw; t = 1 + lg(w) + lg(cw);

}

The technique set forth in Algorithm 1 works because the parity checks from each code of a given weight are independent from each other (so have maximal column rank) and since the minimal column weight is 2, each codeword has a minimal distance of 3, enabling unambiguous single error correction. Note that in the particular case of d=2^{p}−p−1 the above algorithm constructs Hamming codes, and at the other extreme it produces TMR voting—i.e. for p=2d. This is ensured by the careful sorting of the potential rows (described later in this patent) such that all code columns are completed before any new bits are added so that column weights are always within 1 bit of each other.

The value in this construction is that for practical numbers of parity bit redundancy and a given data width, minimal total weight and minimal maximum row weight (optimum latency codes) are directly constructed. Note that the latency and area estimates above are upper bounds, during synthesis, it is likely in many cases that sharing of gates in the decode and parity tree parts of the decoder can result in even better performance and lower cost.

Using Algorithm 1, an example optimal weight code with 6 parity bits and 16 data bits is shown below. This code has total weight 33 and maximum row weight of 6 in comparison to an incomplete Hamming code (5 parity bits) which has total weight 38 and maximal row weight of 8.

$$[ \begin{matrix}1 & 0 & 0 & 0 & 0 & 1 & 1 & 0 & 0 & 0 & 1 & 0 & 1 & 0 & 0 & 1 \\ 1 & 0 & 0 & 1 & 0 & 0 & 0 & 1 & 0 & 0 & 0 & 1 & 0 & 1 & 0 & 1 \\ 0 & 1 & 0 & 1 & 0 & 0 & 1 & 0 & 1 & 0 & 0 & 0 & 0 & 0 & 1 & 1 \\ 0 & 1 & 0 & 0 & 1 & 0 & 0 & 1 & 0 & 1 & 0 & 0 & 1 & 0 & 0 & 0 \\ 0 & 0 & 1 & 0 & 1 & 0 & 0 & 0 & 1 & 0 & 1 & 0 & 0 & 1 & 0 & 0 \\ 0 & 0 & 1 & 0 & 0 & 1 & 0 & 0 & 0 & 1 & 0 & 1 & 0 & 0 & 1 & 0\end{matrix} ]$$

### Replication Codes

A. Code Replication

Although the construction in the previous section was optimal in both total weight (area cost of parity trees) and in row weight (delay of parity trees), it can still be improved as there are many alternative distributions of bits, each with the same total and maximum row weight. From a design perspective, partitioning of large block codes into multiple independent instances of smaller codes is beneficial so long as it does not increase the latency. The rationale for this is to enable coverage of some multiple error scenarios at no added cost and to limit the scope of module wiring in the final design. Latency and row weight are directly related, as such, partitioning can take advantage of larger than minimal numbers of parity bits without impacting latency as long as the maximum row weight of any of the smaller codes is no larger than that of the original code. An example code consisting of 6 data and 6 parity bits is shown below in partitioned and un-partitioned (from Algorithm 1) forms.

$$[ \begin{matrix}1 & 0 & 0 & 0 & 0 & 1 \\ 1 & 0 & 0 & 1 & 0 & 0 \\ 0 & 1 & 0 & 1 & 0 & 0 \\ 0 & 1 & 0 & 0 & 1 & 0 \\ 0 & 0 & 1 & 0 & 1 & 0 \\ 0 & 0 & 1 & 0 & 0 & 1\end{matrix} ] [ \begin{matrix}1 & 1 & 0 & 0 & 0 & 0 \\ 1 & 0 & 1 & 0 & 0 & 0 \\ 0 & 1 & 1 & 0 & 0 & 0 \\ 0 & 0 & 0 & 1 & 1 & 0 \\ 0 & 0 & 0 & 1 & 0 & 1 \\ 0 & 0 & 0 & 0 & 1 & 1\end{matrix} ]$$

Conventional codes exhibit rapid growth in area and latency as block size increases. For example, each parity-check tree of a Hamming implementation requires ½ the codeword as inputs, resulting in large parity trees and relatively high delay from logic fan in, depth, and interconnect costs. For this reason, practical Hamming code implementations partition large words into smaller sizes and build hamming codes on the smaller partitions. This reduces the both latency and gate area at the cost of additional parity bits. Both Hamming and partitioned codes are linear, as such, the claims of weight optimality in the previous section apply to replicated Hamming implementations as well.

When the maximum row weight of any sub-code increases as a result of partitioning, the area and latency cost of the implementation also increase. For example, a code consisting of 20 data and 10 parity bits can be built by Algorithm 1 as a large 2-ary (column weight 2) code with weight 40 and row weight 4. It can also be built using 2 instances of a code consisting of 10 data and 5 parity bits with weight 60 and row weight 6. In many instances it may be preferable to build the partitioned implementation to provide increased error coverage (50% of 2-bit errors) or to minimize wiring.

Memory EDAC solutions may take advantage of partitioning to cater to known or suspected pattern-dependent errors to increase yield or reliability. Partitioning increases total error sustainability by providing independent single-error correctors that work in parallel to recover from many multi-error scenarios. Table 1 illustrates the case for a block of 512 data bits under different conditions. Further, Table 1 illustrates the percent of multi-bit errors covered for a block of 512 data bits with different numbers of partitions scaling (column weight=2).

TABLE 1

| # of | Partition | Parity | | 2-bit | |
|---|---|---|---|---|---|
| Partitions | Size (bits) | Size (bits) | 1-bit errors | errors | 3-bit errors |
| 1 | 545 | 33 | 100% | 0.0% | 0% |
| 2 | 280 | 48 | 100% | 50.0% | 0% |
| 3 | 190 | 57 | 100% | 66.8% | 22.3% |
| 4 | 145 | 68 | 100% | 75.1% | 37.7% |
| 8 | 76 | 96 | 100% | 87.7% | 44.0% |
| 16 | 41 | 144 | 100% | 93.9% | 54.9% |
| 32 | 23 | 224 | 100% | 97.0% | 91.2% |
| 64 | 13 | 320 | 100% | 98.6% | 95.7% |
| 128 | 8 | 512 | 100% | 99.3% | 98.0% |
| 171 | 6 | 513 | 100% | 99.5% | 98.5% |

Total bit overhead is shown to scale quickly, but offers coverage for a substantial number of 2-bit and even 3-bit errors. Even the modest 4 partition scheme provides coverage of 75% of 2-bit errors and over 37% of 3-bit errors with a total bit overhead of only 13%.

B. Partition Generation

Given the advantages of code partitioning, an automated partitioning technique exploiting the optimal weight codes is shown in Algorithm 2. The algorithm builds partitioned codes whenever it is possible to do so given no growth in column weight for any code and with each partition maintaining the rate (ratio of data to parity bits) of the designer input. Algorithm 2 uses two helper functions that automatically determine the optimal weight code for a given data and parity input, and that determine the largest coverage of data bits given a choice of parity bits and column weight. Algorithm 2 starts by finding the rate of the input specification and then iteratively cuts the code into the smallest partitions with the same column weight and code rate as the original. The remaining bits are then checked for feasibility in the next iteration. Note that it is trivial to modify the partitions by changing the column weight constraint. An alternative would be lg₂ of the weight to mimic the gate delay of the parity trees.

Algorithm 2: Partition Generation

Minimal Column Weight Partition(data, parity) {

while (data >0) {

rate=data/parity; wt=weight(data,parity);
cwt=┌wt/parity┐;
if (wt<0) exit; //Impossible code specification
for (p=2;

p <parity&&d=dmax(p,cwt)/p<rate;p++)

dr=data-d; pr=parity-p; //check remainder
if (0< ┌weight(dr,pr)/pr┐≦cwt) { //valid remainder

Algorithm1(d,p);
data=dr; parity=pr;

} else {

Algorithm1(data,parity); //don't partition
exit;

}

}

}
weight(data,parity) { //finds weight of optimal code partition

if(log(data+parity+1)>parity*log(2)) return(−1);
for (r=2w=0; data>0; r++) {

$\begin{matrix}if ( data > ( \begin{matrix}p \\ r\end{matrix} ) ) \\ w = w + r ( \begin{matrix}p \\ r\end{matrix} )\end{matrix}$
else

w=w+r*data;
$data = data - ( \begin{matrix}p \\ r\end{matrix} ) ;$

| | |
|---|---|
| } | return(w); |

}
dmax(parity,cw) { //finds largest data cover for parity, given cw

for (r=2;cw>0&&parity≧r; r++) {

$if ( cw > ( \begin{matrix}p - 1 \\ r - 1\end{matrix} ) ) \{ data = data + ( \begin{matrix}p \\ r\end{matrix} ) ;$
else data=data+└cw*parity/r┘;

$cw = cw - ( \begin{matrix}p - 1 \\ r - 1\end{matrix} ) ;$
}return(data)

}

Using this algorithm, large block codes are automatically broken into sets of smaller codes when it is free or very inexpensive in terms of code weight and block weight. For non-ideal cases, the designer can choose to manually partition the codes.

In these cases, the minimal cost of partitioning is very likely mitigated by the increased efficiency in layout and synthesis of independent components. The resulting implementation also acts as a stronger error mitigator by correcting large numbers of multi-bit errors.

### Results

Due to their large area and low electron charge, memories are a large target for radiation-induced transient faults [2], [1], [8]. Their design makes them well suited for EDAC solutions where data can be cleaned on access [15]. The addition of redundant bits in memories comes at relatively little cost given the uniformity of such regular structures. Classical literature for memory fault tolerance is largely limited to Hamming techniques that are parity-bit minimal, but require very substantial delays due to both logarithmic fan in of the syndrome words and maximally deep parity trees. More recently, it has become popular to partition Hamming codes—effectively adding more redundancy to reduce tree size and hence area and delay.

To measure the effectiveness of the new code family, a set of memory EDAC units can be synthesized in TSMC 90 nm (ultra-low power process) cells using a compiler (e.g., Synopsys Design Compiler™). The sizes chosen can be typical for practical use: 128, 64, 32 and 16 bit. For each size, a variety of designs can be synthesized, from minimal weight 2 codes to codes allowing several partitions for the optimal latency codes and a wide range of partitioned Hamming implementations.

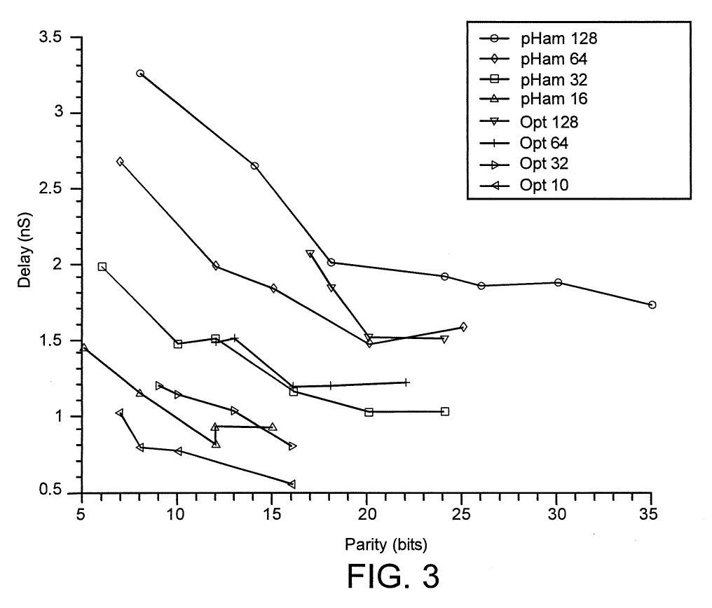

The delay results are depicted in FIG. 3. Thus, FIG. 3 illustrates a synthesized delay of partitioned Hamming and Opt EDAC. The results show a substantial delay improvement—of over 40% in some cases for equivalent numbers of parity check bits. Further, the curves are never close, indicating that the construction is systematically better than multiple copies of conventional Hamming codes. These results are due to the optimized number of parity trees and their heights, leading to savings in both the parity computation and in the decoding logic. Because of the natural partitioning of the new codes, they are also inherently covering a similar number of errors as partitioned Hamming.

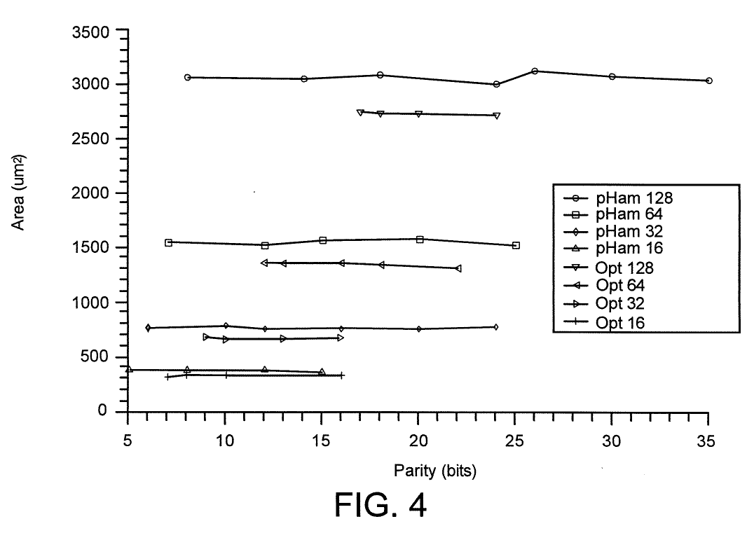

Synthesized area figures for the new codes (e.g., for Partitioned Hamming and Opt) are shown in FIG. 4. These results show a similar trend—the area of the new codes is constant with the data size over a wide range of sizes. (The area doesn't significantly decline until excessive parity check numbers are reached—e.g. parity numbers comparable to the data size). On the other hand, there is a fixed 18-20% reduction in area versus partitioned Hamming results. (The numbers for partitioned Hamming codes might seem smaller than is typical—however since the correction is occurring locally, there is no need to build parity correction circuits. Such circuits have been removed from the Hamming results for fairness in the comparison).

A further set of synthesis procedures can be run to validate the claim that the algorithmic partitioning does not add to either area or delay. Such results are not illustrated herein since the deviations were minimal and likely due to the synthesis process. Note that substantial partitioning is automatically used in the synthesized results. For example, the (128,24) Optimal latency code is constructed as 2 (64,12)

Optimal codes. This partitioning is automatically found by the proposed construction.

### Logical Flow

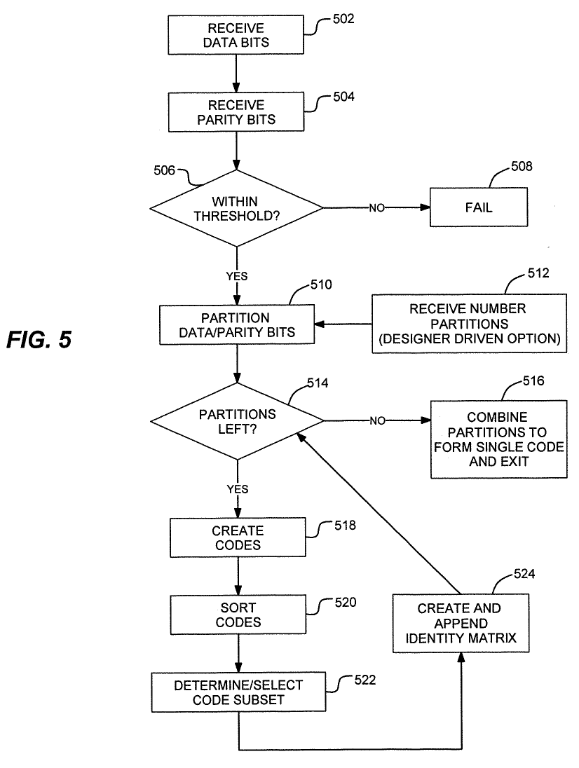

FIG. 5 is a flow chart illustrating the logical flow for building and using a family of low-density linear parity-check (LDPC) codes used for implementing error detection and correction (EDC) in accordance with one or more embodiments of the invention. At step 502 a first number of data bits is received from an operator. At step 504, a second number of parity bits is received from an operator.

At step 506, a determination is made regarding whether the first number of data bits and the second number of parity bits are within a defined threshold with respect to each other. The threshold can be defined as the second number of parity bits is above a minimum number of parity bits with respect to the first number of data bits. In other words, the threshold may be defined as those codes between Hamming codes (d>2^{p}−p−1) and TMR codes (p=2d). In this regard, if there are many more parity bits than there are data bits (p>2d), the construction will only use enough for full TMR as this minimizes the decoding latency. Further, if you have below a minimum number of parity bits (e.g., below the number of parity bits for a Hamming code), then EDC may not be possible. Thus, as stated above, the second number of parity bits (P) may be above a minimum number of parity bits with respect to the first number of data bits (d) of d>2^{p}−p−1.

If the numbers of bits are outside of the designated threshold the system may fail at step 508. At step 510, the data and parity bits may be partitioned based on a number of partitions received at step 512 (e.g., received from an operator pursuant to a designer driven option).

A determination is made at step 514 regarding whether any partitions are left to evaluate. If no partitions are left, the process is complete and exits at step 516. Alternatively, if there are partitions left, at step 518, one or more first LDPC matrix codes are created based on the second number of parity bits. The first LDPC matrix codes are combinations of values for the parity bits.

At step 520, the first LDPC matrix codes are sorted into weight subsections. Each weight subsection contains one or more LDPC matrix codes having a same weight.

At step 522, a subset of each weight subsection is determined/selected based on the first number of data bits. The subset contains those LDPC matrix codes representing a lowest number of inputs to a parity tree for a given parity bit. The LDPC matrix codes representing a lowest number of inputs may further be those LDPC matrix codes having a lowest row weight.

Once the LDPC matrix codewords have been selected, an identity matrix is created and appended to the selected subset at step 524 The size of the identity matrix is based on the first number of data bits. The process then continues at step 514.

In addition to the above, steps 520 and 522 may be performed in accordance with various algorithms. For example, step 522 may be based on the algorithm set forth in Table 2 that sorts a matrix of combinations of weight w for p parity bits (p choose w):

TABLE 2

$m = ( \begin{matrix}p \\ w\end{matrix} ) combinations of weight w for p bits$
s = zero matrix of size (size(m), size(m))
assign_position(m, s)
function assign_position(m, s) {

if (size(m) == 0)

return True

for (i = 0; i < size(m)) {

append m[i] to s

if (!rows_balanced(s)) {

remove last column of s
continue

}
m2 = copy(m)
remove column at index i in m2
if (assign_position(m2, s))

return True

}
return False
}

function rows_balanced(s) {

min = MAX_INT
max = 0
for (i < size(s)) {

w = row_weight(s, i)
if (w < min)

min = w

if (w > max)

max = w

}
return max − min <= 1

}

Alternatively, steps 520 and 522 may be based on the algorithm set forth in Table 3 that builds the complete and sorted matrix of all combination of r bits, with column weight increasing from first to last columns:

TABLE 3

r = number of parity bits
m = matrix(2^{r} − 1, r)
col = 0
for c in range(1, r + 1) {

$p = ( \begin{matrix}r \\ c\end{matrix} )$
bs = r
e = float(r)/float(c)
if e == int(e)

bs = int(e)

b = −1
for i in range(p) {

if (i % bs == 0) {

b += 1
row = 0
w = zero matrix of size(1, r)
wo = 0

}
for k in range(c) {

if k == c − 1:

row = (row + b) % r

while w[row] > wo or m[row][col] == 1:

row = (row + 1) % r

m[row][col] = 1
w[row] += 1
if w == [w[row] for x in range(r)]:

wo += 1

row = (row + 1) % r

}
col += 1

}

}

### CONCLUSION

This concludes the description of the preferred embodiment of the invention. The following describes some alternative embodiments for accomplishing the present invention.

A family of low-cost codes based on analysis of all possible linear codes covering a specified number of data bits specifically for single error correction. A simple, latency and area optimal set of codes offers a variety of design tradeoffs from minimal bit (e.g. Hamming) to voting schemes (e.g. TMR). These codes can be shown to have optimization into partitioned codes that independently solve for local errors. This allows for incidental solution of multiple errors and greatly simplifies the wiring and synthesis requirements for the encoding and decoding circuits. Finally, synthesized versions of a variety of these codes can be shown to be substantially superior to current partitioned Hamming solutions in both area and especially delay. This opens the possibility for run-time cache error correction since the correction latency can be well under the typical memory access delay.

In a broader scope, conventional TMR applications are common but require greater than 3× the area of unprotected logic. The general nature of these codes allows for a designer trade-off of redundancy and delay over a wider range and with greatly increased granularity than is conventionally available. For example, the simplest 2-ary code (6,3) protects 3 bits with 3 bits (instead of the 6 bits required for voting) and requires only 4 levels of logic (versus the 2 required for 3-way voting). Further, optimized coverage of non-uniform error distributions and of non-uniform latency requirements can potentially be performed to satisfy future scaled logic systems.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

### REFERENCES

[1] R. Baumann, “The impact of technology scaling on soft error rate performance and limits to the efficiency of error correction,” 2002, pp. 329-332.
[2] “Soft errors in advanced computer systems,” Design and Test of Computers, IEEE, vol. 22, no. 3, pp. 258-266, 2005.
[3] J. Blome, S. Gupta, S. Feng, S. Mahlke, and D. Bradley, “Costefficient soft error protection for embedded microprocessors,” in CASES '06: Proceedings of the 2006 international conference on Compilers, architecture, and synthesis for embedded systems, 2006, pp. 421-431.
[4] C. Chen and L. Grosbach, “Fault-tolerant memory design in the ibm application system/400,” in FTCS-21: Proceedings of the 1991 International Symposium on Fault-Tolerant Computing, 1991, pp. 393-400.
[5] K. Furutani, K. Arimoto, T. Kobayashi, and K. Mashiko, “A built-in hamming code ecc circuit for dram's,” IEEE Journal of Solid-State Circuits, pp. 50-56, 1989.
[6] R. G. Gallager, “Low-density parity-check codes,” in IRE Transactions on Information Theory, 1962, pp. 21-28.
[7] R. Hentschke, F. Marques, F. Lima, L. Carro, A. Susin, and R. Reis, “Analyzing area and performance penalty of protecting different digital modules with hamming code and triple modular redundancy,” in SBCCI '02: Proceedings of the 15th symposium on Integrated circuits and systems design. Washington, D.C., USA: IEEE Computer Society, 2002, p. 95.
[8] T. Karnik and P. Hazucha, “Characterization of soft errors caused by single event upsets in cmos processes,” Dependable and Secure Computing, IEEE Transactions on, vol. 1, no. 2, pp. 128-143, April-June 2004.
[9] K. Lee, A. Shrivastava, I. Issenin, N. Dutt, and N. Venkatasubramanian, “Mitigating soft error failures for multimedia applications by selective data protection,” in CASES '06: Proceedings of the 2006 international conference on Compilers, architecture, and synthesis for embedded systems, 2006, pp. 411-420.
[10] B. M. Leiner, “Ldpc codes—a brief tutorial,” 2005.
[11] R. Leveugle, “Optimized state assignment of single fault tolerant fsms based on sec codes,” in DAC '93: Proceedings of the 30th international conference on Design automation. New York, N.Y., USA: ACM Press, 1993, pp. 14-18.
[12] M. G. Luby, M. Mitzenmacher, M. A. Shokrollahi, and D. A. Spielman, “Analysis of low density codes and improved designs using irregular graphs,” in In Proceedings of A CM STOC, 1998.
[13] R. E. Lyons and W. Vanderkulk, “The use of triple-modular redundancy to improve computer reliability,” IBM Journal of Resarch and Development 6(2), pp. 200-209, 1962.
[14] D. J. MacKay, Information Theory, Inference, and Learning Algorithms. Cambridge University Press, 2003.
[15] S. Mitra, N. Seifert, M. Zhang, Q. Shi, and K. Kim, “Robust system design with built-in soft-error resilience,” Computer, vol. 38, no. 2, pp. 43-52, February 2005.
[16] R. Rochet, R. Leveugle, and G. Saucier, “Efficient synthesis of fault-tolerant controllers,” in EDTC '95: Proceedings of the 1995 European conference on Design and Test. Washington, D.C., USA: IEEE Computer Society, 1995, p. 593.
[17] A. Shokrollahi, “Ldpc codes: An introduction,” 2003.
[18] C. Stapper, J. Fifield, H. Kalter, and W. Klaasen, “High-reliability fault-tolerant 16-mbit memory chip,” IEEE Transactions on Reliability, pp. 596-603, 1993.
[19] C. H. Stapper and H.-S. Lee, “Synergistic fault-tolerance for memory chips,” IEEE Trans. Comput., vol. 41, no. 9, pp. 1078-1087, 1992.

What is claimed is:

1. A method for building a family of low-density linear parity-check (LDPC) codes used for implementing error detection and correction (EDC) comprising:
(a) receiving a first number of data bits from an operator;
(b) receiving a second number of parity bits from an operator;
(c) while the first number of data bits and the second number of parity bits are within a defined threshold with respect to each other:
(i) creating one or more first LDPC matrix codes based on the second number of parity bits, wherein the first LDPC matrix codes comprise combinations of values for the parity bits;
(ii) sorting the first LDPC matrix codes into weight subsections, wherein each weight subsection comprises one or more LDPC matrix codes having a same weight;
(iii) determining a subset of each weight subsection based on the first number of data bits, wherein the subset comprises those LDPC matrix codes representing a lowest number of inputs to a parity tree for a given parity bit; and
(d) appending an identity matrix of a size of the first number of data bits to the subset.

2. The method of claim 1 wherein the defined threshold comprises:
the first number of data bits is greater than the second number of parity bits; and
the second number of parity bits is above a minimum number of parity bits with respect to the first number of data bits.

3. The method of claim 2, wherein the second number of parity bits (P) is above a minimum number of parity bits with respect to the first number of data bits (d) based on d>2^{p}−p−1.

4. The method of claim 1 wherein those LDPC matrix codes representing a lowest number of inputs to a parity tree for a given parity bit comprise LDPC matrix codes having a lowest row weight.

5. The method of claim 1 further comprising while the first number of data bits and second number of parity bits are within a defined threshold with respect to each other:
(i) dividing the first number of data bits into two or more subsets based on the first number of data bits and the second number of parity bits;
(ii) creating one or more additional first LDPC matrix codes, wherein each additional first LDPC matrix code is based on a respective subset; and
(iii) creating a second LDPC matrix code comprising two or more first LDPC matrix codes.

6. A method of data transmission using a family of low-density linear parity-check (LDPC) codes comprising:
(a) receiving input data;
(b) receiving a LDPC matrix, wherein the LDPC matrix is obtained by:
(i) receiving a first number of data bits from an operator;
(ii) receiving a second number of parity bits from an operator;
(iii) while the first number of data bits and the second number of parity bits are within a defined threshold with respect to each other:
(1) creating one or more first LDPC matrix codes based on the second number of parity bits, wherein the first LDPC matrix codes comprise combinations of values for the parity bits;
(2) sorting the first LDPC matrix codes into weight subsections, wherein each weight subsection comprises one or more LDPC matrix codes having a same weight;
(3) determining a subset of each weight subsection based on the first number of data bits, wherein the subset comprises those LDPC matrix codes representing a lowest number of inputs to a parity tree for a given parity bit; and
(iv) appending an identity matrix of a size of the first number of data bits to the subset; and
(c) encoding the input data using the LDPC matrix to produce output data.

7. The method of claim 6 wherein the defined threshold comprises:
the first number of data bits is greater than the second number of parity bits; and
the second number of parity bits is above a minimum number of parity bits with respect to the first number of data bits.

8. The method of claim 7, wherein the second number of parity bits (P) is above a minimum number of parity bits with respect to the first number of data bits (d) based on d>2^{p}−p−1.

9. The method of claim 6 wherein those LDPC matrix codes representing a lowest number of inputs to a parity tree for a given parity bit comprise LDPC matrix codes having a lowest row weight.

10. The method of claim 6 further comprising while the first number of data bits and second number of parity bits are within a defined threshold with respect to each other:
(i) dividing the first number of data bits into two or more subsets based on the first number of data bits and the second number of parity bits;
(ii) creating one or more additional first LDPC matrix codes, wherein each additional first LDPC matrix code is based on a respective subset; and
(iii) creating a second LDPC matrix code comprising two or more first LDPC matrix codes.

11. A digital circuit data transmission apparatus comprising:
(a) a low density parity check (LDPC) encoder for encoding input data, wherein the encoder is configured in accordance with:
(i) a first number of data bits received from an operator;
(ii) a second number of parity bits received from an operator;
(iii) while the first number of data bits and the second number of parity bits are within a defined threshold with respect to each other:
(1) one or more first LDPC matrix codes are created based on the second number of parity bits, wherein the first LDPC matrix codes comprise combinations of values for the parity bits;
(2) the first LDPC matrix codes are sorted into weight subsections, wherein each weight subsection comprises one or more LDPC matrix codes having a same weight;
(3) a subset of each weight subsection is determined based on the first number of data bits, wherein the subset comprises those LDPC matrix codes representing a lowest number of inputs to a parity tree for a given parity bit; and
(iv) an identity matrix of a size of the first number of data bits is appended to the subset.

12. The apparatus of claim 11 wherein the defined threshold comprises:
the first number of data bits is greater than the second number of parity bits; and
the second number of parity bits is above a minimum number of parity bits with respect to the first number of data bits.

13. The apparatus of claim 12, wherein the second number of parity bits (P) is above a minimum number of parity bits with respect to the first number of data bits (d) based on d>2^{p}−p−1.

14. The apparatus of claim 11 wherein those LDPC matrix codes representing a lowest number of inputs to a parity tree for a given parity bit comprise LDPC matrix codes having a lowest row weight.

15. The apparatus of claim 11 wherein while the first number of data bits and second number of parity bits are within a defined threshold with respect to each other:
(i) the first number of data bits is divided into two or more subsets based on the first number of data bits and the second number of parity bits;
(ii) one or more additional first LDPC matrix codes are created, wherein each additional first LDPC matrix code is based on a respective subset; and
(iii) a second LDPC matrix code is created that comprises two or more first LDPC matrix codes.
